(19) United States
(12) Patent Application Publication
(10) Pub. No.: US 2019/0051079 A1
(43) Pub. Date: Feb. 14, 2019

(54) CRYPTOGRAPHICALLY TRACKED AND SECURED VOTE BY MAIL SYSTEM

(71) Applicant: United States Postal Service, Washington, DC (US)

(72) Inventors: Mohan Venkataraman, Raleigh, NC (US); Wendy Henry, Arlington, VA (US); Aashish Shrestha, Raleigh, NC (US); Angela M. Lagneaux, Odenton, MD (US); Stephen M. Dearing, Herndon, VA (US); Ronald E. Garey, Washington, DC (US); Suzanne N. Dunn, Selma, NC (US)

(21) Appl. No.: 16/101,248

(22) Filed: Aug. 10, 2018

Related U.S. Application Data
(60) Provisional application No. 62/544,711, filed on Aug. 11, 2017.

(51) Int. Cl. G07C 13/00; H04L 9/32

(52) U.S. Cl. CPC G07C 13/00; H04L 9/32

(57) ABSTRACT

A vote by mail system that also cryptographically tracks and secures votes is described herein. In some embodiments, the mail system cryptographically tracks and secures votes through the use of a block chain like those used in cryptographic currencies. In some embodiments, the block chain is used to record some data regarding the mailed in votes in order to demonstrate the accuracy of the election. In some embodiments, they system also allows voters to vote using scanned versions of ballots received by mail. Further, in some embodiments, the system coordinates the mailing of absentee ballots that can then be used with the system.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

This development relates to a vote by mail system that also incorporates the use of cryptographic elements, such as block chains, as are used with cryptographic currencies, to track and secure the vote by mail system.

### Description of the Related Art

Voters generally wish to be able to vote for elected officials or on other issues in a manner that is convenient and secure. Further, those holding elections wish to be able to ensure that election results have not been tampered with and that the results actually correspond to the votes that were cast. In some embodiments, a block chain allows the tracking of the various types of necessary data in a way that is secure and allows others to easily confirm that data has not been altered.

### SUMMARY

Described herein is a system for secure voting. In some embodiments, the system comprises a computer processor configured to process ballot creation information to create a ballot template, process voter identification information to create at least one pseudo-anonymous voter ID, and generate at least one ballot using the ballot template and pseudo-anonymous voter ID. In some embodiments, the system can further comprise a communication device configured to provide the at least one ballot to a voter associated with pseudo-anonymous voter ID. In some embodiments, the system can further comprise a secure database configured to receive ballot selections from the voter; and store the ballot selections in a manner associated with the at least one pseudo-anonymous voter ID.

In some embodiments, the computer processer is further configured to generate a token associated with a particular pseudo-anonymous voter ID that allows the voter associated with the particular pseudo-anonymous voter ID to vote in a particular election.

In some embodiments, the system can further comprise a printer configured to print a physical ballot based on the at least one ballot generated the computer processor.

In some embodiments, the secure database is further configured to retrieve the ballot selections when requested by the voter associated with the at least one pseudo-anonymous voter ID.

In some embodiments, the secure database is further configured to only store the ballot selections upon receiving a scan of a physical ballot containing an identifier associated with the particular pseudo-anonymous voter ID.

Further described herein is a method for secure voting, the method comprising processing ballot creation information to create a ballot template; processing voter identification information to create at least one pseudo-anonymous voter ID; generating at least one ballot using the ballot template and pseudo-anonymous voter ID; providing the at least one ballot to a voter associated with pseudo-anonymous voter ID; receiving ballot selections from the voter; and storing the ballot selections in a manner associated with the at least one pseudo-anonymous voter ID.

In some embodiments, the method can further comprise generating a token associated with a particular pseudo-anonymous voter ID that allows the voter associated with the particular pseudo-anonymous voter ID to vote in a particular election.

In some embodiments, the method can further comprise printing a physical ballot based on the at least one ballot generated the computer processor.

In some embodiments, the method can further comprise retrieving the ballot selections when requested by the voter associated with the at least one pseudo-anonymous voter ID.

In some embodiments, the method can further comprise storing the ballot information on a block chain.

In some embodiments, the method can further comprise only storing the ballot selections upon receiving a scan of a physical ballot containing an identifier associated with the particular pseudo-anonymous voter ID.

Further described herein are some embodiments of a system for secure voting that can comprise a computer processor configured to create a ballot template using ballot creation information, create a pseudo-anonymous voter ID using voter identification information, and generate at least one ballot using the election template and pseudo-anonymous voter ID. The system can further comprise a printer configured to print a physical ballot based on the generated at least one ballot, the ballot comprising a ballot identifier based on the pseudo-anonymous voter ID. The system can further comprise a mail processing device configured to receive the physical ballot from a voter and associate the physical ballot with the voter based on the ballot identifier.

In some embodiments, the mail processing device is further configured to identify the address of the entity responsible for counting the votes on the physical ballot based on ballot identifier; and direct the physical ballot on to the entity responsible for counting the votes on the physical ballot.

In some embodiments, the system can further comprise a secure database configured to receive ballot selections from the voter; and determine if the secure database had previously received ballot selections from the same voter.

In some embodiments, the secure database is further configured to flag the voter for a fraud investigation if the secure database had previously received ballot selections from the same voter.

In some embodiments, the secure database is further configured to designate at least one of the ballot selections to not be counted in a final vote tally.

Further described herein are some embodiments of a method for secure voting that can comprise creating a ballot template using ballot creation information; creating a pseudo-anonymous voter ID using voter identification information; and generating at least one ballot using the election template and pseudo-anonymous voter ID; printing a physical ballot based on the generated at least one ballot, the ballot comprising a ballot identifier based on the pseudo-anonymous voter ID; receiving the physical ballot from a voter; and associating the physical ballot with the voter based on the ballot identifier.

In some embodiments, the method can further comprise identifying the address of the entity responsible for counting the votes on the physical ballot based on ballot identifier; and directing the physical ballot on to the entity responsible for counting the votes on the physical ballot.

In some embodiments, the method can further comprise receiving ballot selections from the voter; and determining if a secure database had previously received ballot selections from the same voter.

In some embodiments, the method can further comprise flagging the voter for a fraud investigation if the secure database had previously received ballot selections from the same voter.

In some embodiments, the method can further comprise designating at least one of the ballot selections to not be counted in a final vote tally.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with the additional specificity and detail through use of the accompanying drawings.

FIG. 1 shows an exemplary system architecture for the block chain management portion of a vote by mail system.

FIG. 2 displays an object model that demonstrates the interaction between various software objects in the block chain powered vote by mail system

FIG. 3 shows a software hierarchy diagram for the various ways different users can interact with the block chain access layer.

FIG. 4 is a software hierarchy diagram of the various software modules that can be used by the block chain access layer.

FIGS. 5a-5g display various screens of one embodiment of a voting application, user interface, or website.

FIG. 6 depicts a message flow diagram of an embodiment of voter registration.

FIG. 7 depicts a message flow diagram of an embodiment of a log in process.

FIG. 8 depicts a message flow diagram of an embodiment of a process of providing an absentee ballot.

FIG. 9 depicts a message flow diagram of an embodiment of a process for registering for an election.

FIG. 10 depicts a message flow diagram of an embodiment of a process for mailing ballots.

FIG. 11 depicts a message flow diagram of an embodiment of a process of receiving and submitting a mailed ballot.

FIG. 12 depicts a message flow diagram of an embodiment of a process creating an election template.

FIG. 13 depicts a message flow diagram of an embodiment of a process for creating a ballot template.

### DETAILED DESCRIPTION

In some embodiments a vote by mail system can be secured, for example, using a block chain to record some data regarding the mailed in votes in order to demonstrate the accuracy of the election. In some embodiments, the system also allows voters to vote using scanned versions of ballots received by mail. Further, in some embodiments, the system coordinates the mailing of absentee ballots that can then be used with the system.

In some embodiments of the vote by mail system, an election official can create a template ballot for use by potential voters. Voters can then apply to the system to allow them to receive a mailed absentee ballot. The system can verify the identity of the voter and create a pseudo-anonymous token in the form of a unique identifier that represents the voter. In some embodiments, the vote by mail system then generates a paper ballot that is printed with a QR code, barcode, or other computer or machine readable identifier that represents the token. In some embodiments, the machine-readable identifier is a United States Postal Service Electronic Postmark (EPM®), or is a code or identifier associated with an EPM®. The paper ballot having the identifier thereon can then be mailed to the voter that corresponds to that token.

In some embodiments, the voter can receive the paper ballot and use a mobile device or other computer to scan the ballot with a camera. The voter can then use the mobile device to cast digital votes, which are then written to the block chain. The voter can then mail the blank ballot back to the registrar. In some embodiments, the voter does not vote electronically, but instead fills out the paper ballot and sends it to the registrar. In some embodiments, the QR code, barcode, or other computer or machine readable identifier on the printed out ballot can be used to verify the that the ballot was properly submitted by a registered voter.

In some embodiments, the registrar can receive the ballot, scan the ballot's QR code, barcode, or other code, certify that the voter has voted and then ensure that the digital votes are added to the vote tallies of the candidates for election on the ballot. In other embodiments, the registrar can receive the completed ballot, and then either scan in or otherwise convert the votes on the paper ballot into digital votes, add those votes to the block chain, certify the voter has voted, and ensure that the digital votes are added to the vote tallies of the candidates for election on the ballot.

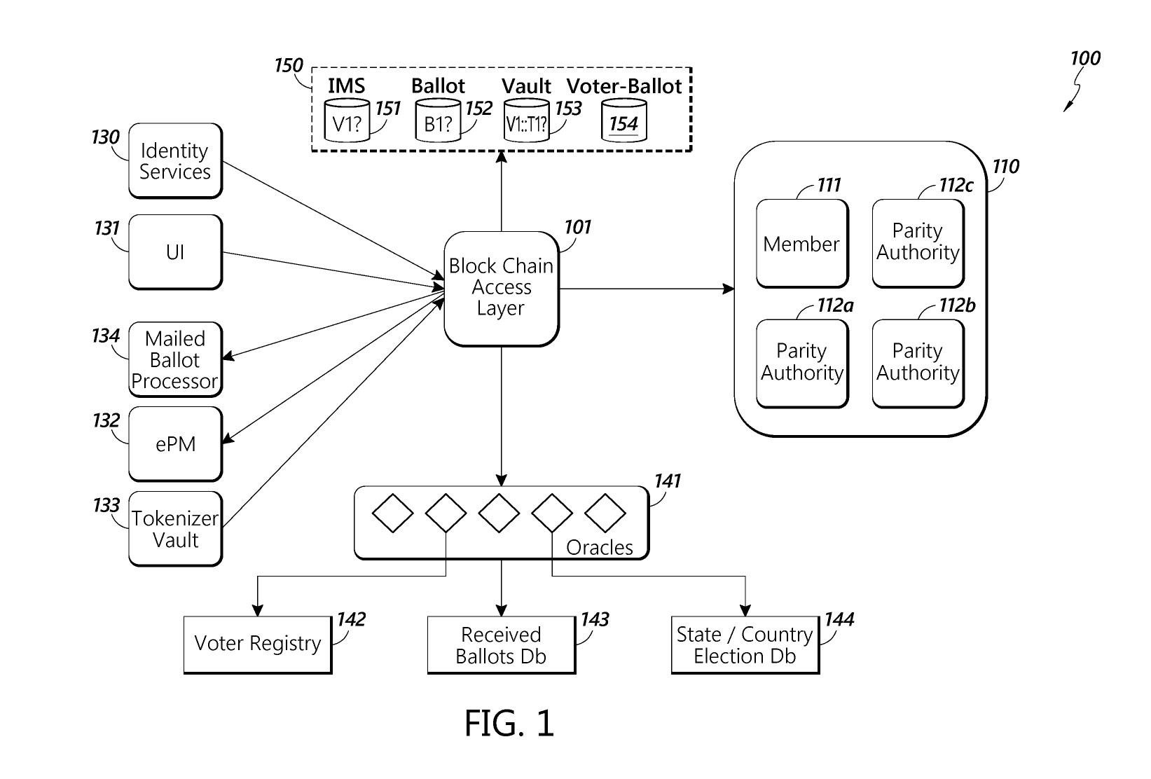

FIG. 1 depicts exemplary system architecture for the block chain management portion of a block chain powered vote by mail system. The exemplary system architecture 100 contains a block chain access layer 101. Block chain access layer 101 provides access to the block chain (not shown) for the various system architecture components. It also can coordinate all of the non-block chain related functions of the system. In some embodiments, the block chain is a digital ledger in which state changes are recorded. In some embodiments, the accuracy of the block chain is ensured through the use of cryptographic functions such that previous entries in the ledger cannot not be altered without the alteration of all subsequent parts of the ledger. In some embodiments, the block chain is separated into “blocks” of data, wherein each block contains a hash of the data of the previous block. In some embodiments, the block chain is separated into different blocks based upon the number of entries on the digital ledger or on the amount of data stored in the digital letter. For example, each block could contain 10, 100, 1,000 or 1,000,000 ledger entries or other number of entries. Each block could also contain 10, 100, 1,000 or 1,000,000 Mb of data, or other amount of data.

In some embodiments, the block chain can be used to defeat fraud because cryptographic functions that ensure the accuracy of the block chain prevent bad actors hoping to perpetuate fraud from altering the block chain. In some embodiments, the block chain can also be used by voters to check to make sure their votes were received and counted because the block chain provides an easily accessible and robust method of recording voting actions in an unalterable way.

The embodiments of the data stored on the block chain in the exemplary system architecture are discussed further below. In some embodiments, the block chain is based on the Ethereum open software platform or other similar platforms. In some embodiments, the platform is a Turing complete block chain protocol. In some embodiments, the block chain access layer uses software “contracts” that write data to the block chain when certain conditions are met. In some embodiments, the “contracts” can be used to develop software objects such as those further described below.

In some embodiments, block chain access layer 101 is in wired or wireless communications with entities 110 that can interact with the block chain directly. In some embodiments the entities 110 communicate with the block chain access layer through a software API (not shown). In some embodiments, this can be REST-API. In some embodiments, the entities comprise a member 111 that can act as a committer on the block chain. A committer can add validated transactions to the block chain, thereby writing data to the ledger.

In some embodiments, the entities also include parity authorities 112a-c. Parity authorities 112a-c act as validators for the transactions entered onto the block, ensuring that the transactions accurately reflect what happened. In some embodiments, the parity authorities 112a-c can be used as part of a consensus mechanism known as Proof of Authority (PoA). Instead of using miners to validate and create blocks on the blockchain, PoA relies on a group of nodes referred to as authority nodes or validators contained within the parity authorities. Using a round-robin structure, each authority node gets a time slot per round in which it can create and sign one new block. In case a validator is offline or not responding, it will be skipped. The validator signing a block is called the primary. In some embodiments, at least five authority nodes will be allocated among the parity authorities. In some embodiments, each parity authority can have more than one node.

In some embodiments, block chain access layer 101 is also in communication with identity services 130. In some embodiments, identity services 130 can communicate with the block chain access layer 101 through a software API. In some embodiments, this can be REST-API.

Identity services 130 allow the system to ensure that voters who are registered with the system are who they say they are. In some embodiments, the voters enter proof and other required documentation into the system through user interface 131.

In some embodiments, the block chain access layer 101 can be in communication with a user interface 131. In some embodiments, the block chain access layer 101 can communicate with the user interface 131 through an internet or other software protocol. In some embodiments, this can by Hyper Text Transfer Protocol or Hyper Text Transfer Protocol Secure. The user interface 131 allows the various users of the system, also called participants, to interact with the system. In some embodiments, there are three types of participants who can interact with the system: voters, election registrars, and notaries. Each of these types of users can interact with the system in different ways through the user interface, as described further below.

Identity services 130 then submits these proofs provided through user interface 131 to various authorities to ensure that the person's alleged identity is correct. In some embodiments, these authorities could be the FBI, Equifax, the Social Security Administration, a state department of motor vehicles, or another agency that confirm identities. The identity services 130 can then generate a unique voter ID and a public/private key pair for each voter, store them appropriately, and notify the voter. In some embodiments, the identity services 130 can store the various data in a JSON data structure.

In some embodiments, the block chain access layer 101 is in communication with electronic Postmark® system 132. In some embodiments, electronic Postmark® system 132 operates in the manner describe in U.S. Patent Application No. 62/133,173, filed on Mar. 13, 2015, hereby incorporated in its entirety by reference. In some embodiments, the electronic Postmark® system 132 can be used to generate and verify barcodes or other computer or machine readable identifier attached to physical ballots that are sent out to allow users to vote by mail. In some embodiments, these barcodes or other computer or machine readable identifier can then be used to electronically submit votes in elections and to certify that voters submitted their results.

In some embodiments, the block chain access layer 101 is in communication with a tokenizer vault 133. Tokenizer vault 133 tokenizes an individual ballot cast by a voter. In order to cast a vote in the digital system the voter must be assigned a token corresponding to the election by the tokenizer vault 133. In some embodiments, the token can also correspond to a particular EPM® associated with a voter. This enables the submission of a physical ballot by mail in an anonymous manner and the simultaneous creation of a digitized version using block chain technology for added security.

In some embodiments, tokenizer vault 133 can issue multiple tokens that perform these functions. For example, the tokenizer vault 133 can issue separate ballot and obfuscation tokens. In some embodiments, a ballot token is a unique identifier that is generated for a specific user who signs up for voting in absentia in a specific election and is printed on the mailed ballot. This token authorizes the voter to one ballot submission for that election.

In some embodiments, the tokenizer vault 133 can also issue pseudo-anonymous obfuscation tokens to voters. In some embodiments, in order to cast a vote in the digital system, the voter must be assigned an obfuscation token corresponding to the election by the tokenizer vault 133. In some embodiments, the obfuscation toke is issued using an acceptable algorithm to represent an anonymized ID of the voter that is securely stored by a Key Management Service/Key Vault. All user transactions are subsequently anonymized and recorded on the block chain using the token. The obfuscation token is kind-of a Zero Knowledge Proof identifier. In some embodiments, the obfuscation token can also correspond to a particular EPM® associated with a voter.

In some embodiments, the block chain access layer 101 is in communication with a mailed ballot processor 134. In some embodiments, the mailed ballot processor 134 can be used to analyze and identify ballots received by mail. In some embodiments, mail ballot processor 134 can read barcodes or other computer or machine-readable identifiers attached to physical ballots that are sent out to allow users to vote by mail and determine information about the received ballot. For example, the mailed ballot processor 134 can determine if a mailed ballot was received in time for the votes to count in the election based on the time that the machine-readable identifier was scanned by a mail processing system. In some embodiments, the mail ballot processor 134 can also be used to determine which entity should count a particular received ballot or to which entity, location, or facility the mailed ballot should be returned. For example, some elections may require that the ballots be counted by a local state or county authority. In some embodiments, the mail ballot processor 134 can determine the appropriate entity based on the machine-readable identifier. For example, the mail ballot processor 134 can determine the address of the voter based on the machine readable identifier and then determine that votes from that address should be sent to be counted at a particular county or state office. The mail ballot processor could then direct the mailed in ballot to be sent on to the appropriate office.

In some embodiments, the block chain access layer 101 can be in communication with oracles 141. In some embodiments, oracles 141 are software services responsible for communicating and interfacing with systems outside of the block chain powered voting system and then input information from those systems into the block chain access layer. In some embodiments, oracles 141 can communicate with block chain access layer 101 through a software API. In some embodiments, this API can be REST-API or RabbitMQ. In some embodiments, the oracles 141 can communicate with various state level election systems. For example, oracles 141 can interact with a state level voter registry 142. Voter registry 142 can be a database that contains all of the voters that are registered to vote in that state. In some embodiments, oracles 141 can interact with a state level received ballots database 143. In some embodiments, this database contains information on all of the voting ballots received by the state. In some embodiments, this information can then be transferred into and stored in voter-ballot database 154, as discussed below. Oracles 141 can also interact with a state level state/county election database 144. State/county election database 144 contains all the information on what elections are happening in the state/county. In some embodiments, this includes what positions are up for election and who the candidates are for each position.

In some embodiments, the block chain access layer 101 is in communication with databases 150. In some embodiments, databases 150 can store the various information that is received by the block chain access layer 101. In some embodiments, the databases 150 can contain all of the information that is not contained on the block chain itself. In some embodiments, databases 150 are maintained and hosted by a single entity, such as the United States Postal Service In some embodiments, databases 150 can contain an identity management services database 151. In some embodiments, identity management services database 151 can contain all of the information on the voters that is received by the block chain, both from the voters directly through user interface 131, and through identity services 130.

In some embodiments, databases 150 can contain a ballot database 152. The ballot database 152 can contain all the information on a generic, or template, ballot that is received by the block chain access layer 101. For example, the database can contain information on specific ballot templates that show the various categories and sub-categories of the open positions and the candidates (including their affiliation) who are running for those positions, and any “ballot measures” seeking citizen referendum.

In some embodiments, databases 150 can contain a vault database 153. The vault database 153 is a secure database that maintains the correspondence between voters and the tokens that are assigned to the voters. In some embodiments, the vault can store an alphanumeric voterID for each voter, and correspond that ID to an alphanumeric electionID that identifies a particular election and a token that indicates that the voter can vote in that election. In some embodiments, the vault database 153 can also store an electronic postmark that corresponds to individual voters.

In some embodiments, databases 150 can also contain a voter-ballot database 154. The voter-ballot database 154 stores the electronic completed ballots submitted by the voters. In some embodiments, the voter-ballot database 154 can also contain ballots submitted by voters, either via electronic voting through a mobile app or website as described further below, through a mailed ballot, or from a voting machine at a polling place. In some embodiments, the record of votes includes information gathered by a particular state or county's database. In some embodiments, the voter-ballot database 154 can determine if a particular voter has voted more than once based on the identifier received with each ballot or which is associated with each ballot. For example, the voter-ballot database can determine that a particular voter voted both at polling place by receiving a voting indentifier from a voting machine at a polling place and by the identifier received a mail-in ballot. The voting can remain anonymous, and only the comparison or match between identifiers will be noted.

In some embodiments, if the voter-ballot database 154 detects multiple votes, or identifies a match between an identifier from a voting machine at a polling place and an identifier on a mail-in ballot, it can take certain actions. For example, it could flag the voter for review for fraud or it could prioritize certain types of votes over others. For example, the voter-ballot database 154 may prioritize the polling place vote over a mailed-in ballot or voting app vote. If there is a match between an identifier from a voting machine and an identifier on a mail-in ballot, or if there is a record of multiple votes from one voter, the mail-in ballot may be discarded. In some embodiments, when this situation is detected, the vote from the voting machine may be discarded in favor of the mail-in ballot.

In some embodiments, the various aspects of the system architecture described in FIG. 1 can operate on or be a component of a processing system implemented with one or more processors. The system architecture may operate on a network of interconnected processors housed on one or more terminals. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The processors may comprise, for example, a microprocessor, such as a Pentium® processor, a Pentium® Pro processor, a 8051 processor, a MIPS® processor, a Power PC® processor, an Alpha® processor, a microcontroller, an Intel CORE i7®, i5®, or i3® processor, an AMD Phenom®, A-series®, or FX® processor, or the like. The processor or processors typically has conventional address lines, conventional data lines, and one or more conventional control lines. The processor or processors may be in communication with a processor memory, which may include, for example, RAM memory, flash memory, ROM memory, EPROM memory, EEPROM memory, registers, hard disk, a removable disk, a CD-ROM, or any other form of storage medium known in the art. The processor memory may include, for example, software, at least one software module, instructions, steps of an algorithm, or any other information. In some embodiments, the processor or processors performs processes in accordance with instructions stored in the processor memory. These processes may include, for example, controlling features and/or components of the block chain powered vote by mail system architecture 100, and controlling access to and from, and transmitting information and data to and from the block chain powered vote by mail system architecture and the constituent components of the block chain powered vote by mail system architecture 100, as described herein.

The processor or processors that are running vote by mail system architecture can also be in communication with system memory, configured to store information, such as confidence data, item-carrier information, expected deliveries data and the like. The system memory may comprise a database, a comma delimited file, a text file, or the like.

In some embodiments, the processor or processors is/are connected to a communication feature. The communication feature is configured for wired and/or wireless communication. In some embodiments, the communication feature communicates via telephone, cable, fiber-optic, or any other wired communication network. In some embodiments, the communication feature may communicate via cellular networks, WLAN networks, or any other wireless network. The communication feature is configured to receive instructions and to transmit and receive information among components of the vote by mail system architecture and, in some embodiments, with a central server (not shown) or other resource outside the vote by mail system architecture, as desired.

In some embodiments, the components of the vote by mail system architecture 100 can operate on a virtual processor and a virtual memory in a cloud based system. In some embodiments, this cloud based system can be as described on pages 2 and 3 of Appendix A attached to this application.

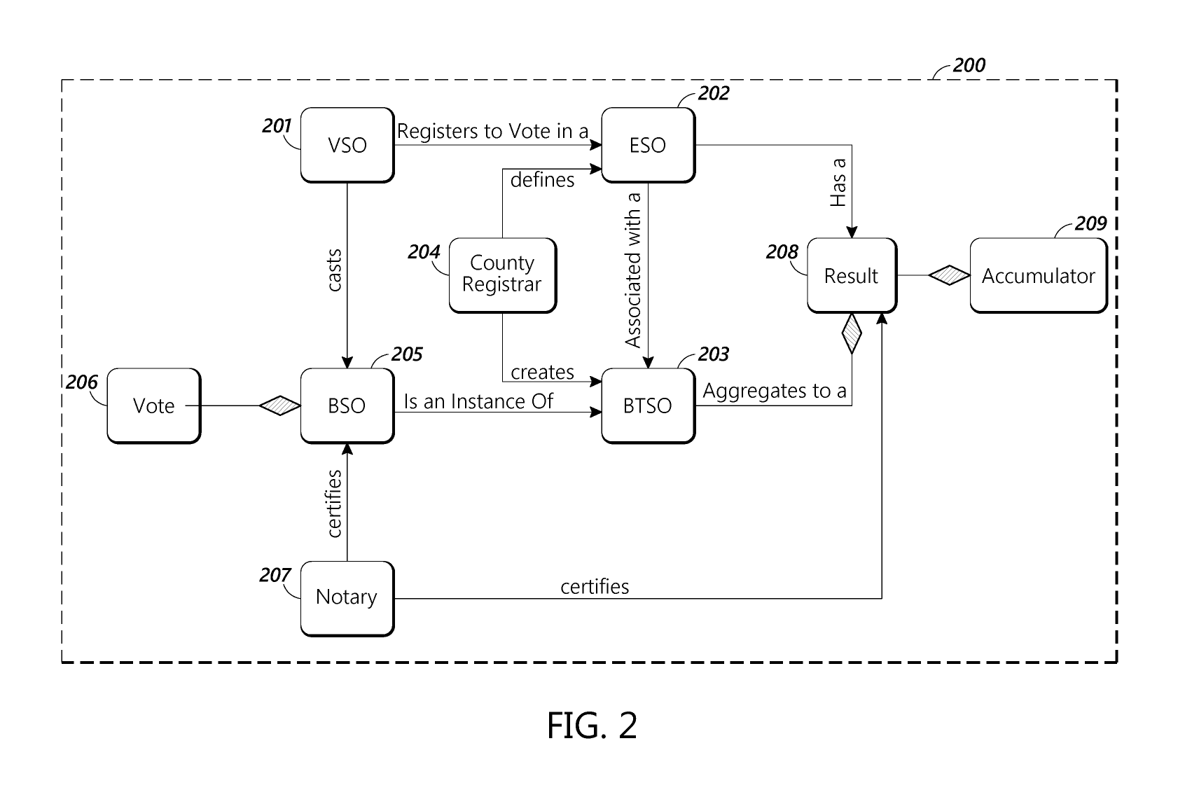

FIG. 2 displays an object model that demonstrates the interaction between various software objects in a vote by mail software system 200. In some embodiments, one software object is a voter 201 (“VSO 201”). VSO 201 is a software object representing any individual who is a US citizen over the age of 18 and meets the state's residency requirements with the exception of certain mentally incapacitated persons or those with certain types of criminal records. In some embodiments, a specific VSO 201 stores data about a specific voter. For example, the VSO 201 can store a voter digital id, a voter name, a voter jurisdiction, a voter permanent mailing address, voter current address, voter verification number, and other voter details. In some embodiments, the VSO 201 also contains voter identification information, such as a voter digital ID, assigned by identity services 130, a voter public key and private key, assigned by identity services 130, and a token to vote assigned by tokenizer vault 133.

In some embodiments, the vote by mail software system 200 can registers VSO 201 to vote in an election software object 202 (“ESO 202”). An ESO 202 is a definition of the basic attributes of the process for filling open positions for “Public Office” in the federal, state, county or municipality, or determining the course of action to be taken on public policy issues through a voter referendum. In some embodiments, the ESO 202 can contain information on a specific election such as, an alpha-numeric election ID, a description of the election, the state and county the election is taking place in, the various candidates, positions, and public referendums on the federal, state, county, local, and municipal positions and issues to be voted on, the date of the election and the status of the election.

In some embodiments, vote by mail software system 200 can associate ESO 202 with a ballot template software object 203 (BTSO 203). In some embodiments, BTSO 203 elaborates the details of an election. For example BTSO 203 can be a State/County specific template showing the various categories and sub-categories of the open positions and the candidates (including their affiliation) who are running for those positions, and any “ballot measures” seeking citizen referendum. In some embodiments, a unique identifier is assigned to each ballot based on the election and the voter receiving the ballot and is then used to mail that ballot to a voter.

In some embodiments, vote by mail software system 200 uses county registrar software object 204 (CRSO 204) to define an election and create a ballot template. In some embodiments, CRSO 204 helps to define the elections and create the ballot. CRSO 204 varies by what state the block chain powered vote by mail system is implemented in. In some embodiments, the CRSO 204 can help the actual physical county registrar certify the official lists of candidates running for state offices, advise candidates and local elections officials on the qualifications and requirements for running for office, provide guidance on how candidates can select acceptable candidate ballot designations, determine the order in which candidates are placed on the ballot, track and certify ballot initiatives, coordinate the tabulation of the votes from each county on election night, and use its voter registration and outreach team to produce voter registration forms, voter information publications, and encourage people to register and vote.

In some embodiments, vote by mail software system 200 can receive input from an actual voter and can then “cast” or create ballot software object 205 (BSO 205), which is a specific instance of BTSO 203. BSO 205 is completed ballot template 203 and is associated with a VSO 201 of the voter that provided the input that was used to fill out BSO 205. In some embodiments, BSO 205 contains a collection of vote software objects 206, which represent the actual votes cast by the voter that corresponds to a specific VSO 201.

In some embodiments, the vote by mail software system 200 can use notary software object 207 (NSO 207) to certify that BSO 205 was correctly cast. In some embodiments, the NSO 207 certifies that BSO 205 was correctly cast by verifying a hash provided with the BSO 205 with its own computation.

In some embodiments, the NSO 207 will also certify results software object 208 (RSO 208), which is an aggregate of all of the casted votes and represents the result of the election. In some embodiments, the NSO 207 similarly certifies RSO 208 by verifying a hash provided with the RSO 208 with its own computation. RSO 208 is calculated by the vote by mail software system 200 using the accumulator software object 209 (ASO 209). ASO 209 appropriately buckets each vote received to the receiving candidate. ASO ensures each vote that is recorded is counted properly and can summarize the votes received by various categories.

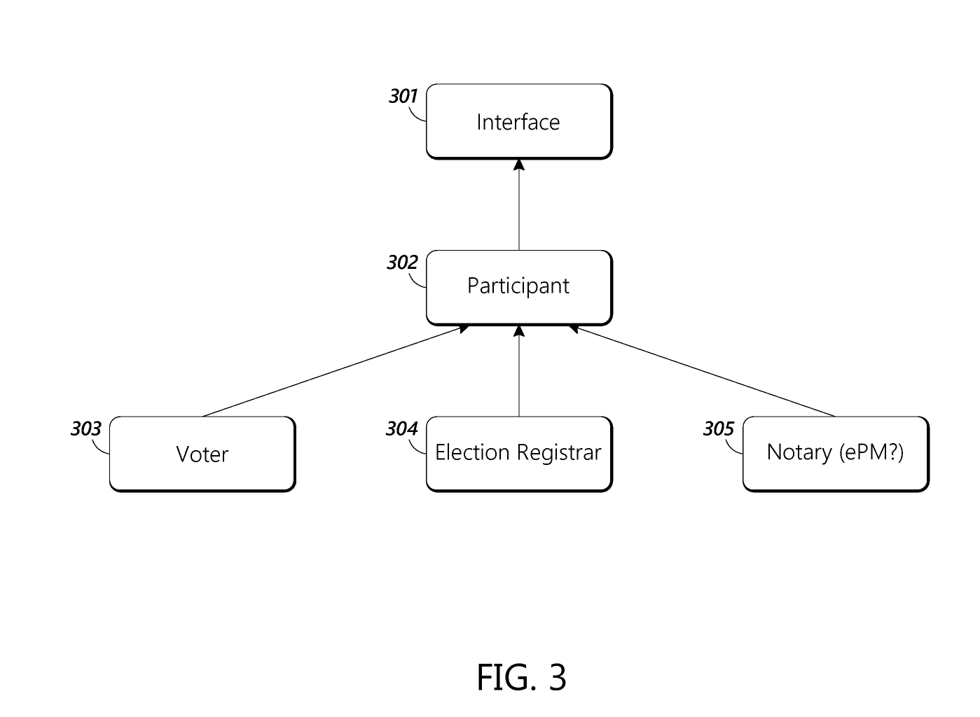

FIG. 3 shows a software hierarchy diagram for the various ways different users can interact with the block chain access layer 101 through user interface 131. In some embodiments, different users have access to different functions that they can use to perform actions through block chain access layer 101. At the highest level, all types of users can interact with block chain access layer 101 through the functions contained through an interface 301 software object. In some embodiments, interface 301 is a software object contained within user interface 131 and utilized user interface 131. Interface 301 allows users to access basic block chain functions. For example, interface 301 allows all users to verify the connection to the block chain, instantiate an API that allows control of the block chain access layer and also allows the users to interact with databases 150. In some embodiments, this interface can be a BaseWeb3 type interface.

The next hierarchical level is a participant 302 software object. Participant 302 is a software object that interacts with interface 301 to allow users to perform functions common to all users. In some embodiments, participants can use the interface 301 to create an account on the block chain access layer 101, create a user on the block chain access layer 101, generate a public and private key pair for the user that is used for signing transactions entered onto the block chain, login to the system, and sign specific transactions. Participants can also come in three categories: voters, registrars, and notaries. Each category can perform additional specific functions for that particular category of participants.

For example, some participants are voters 303. In some embodiments, voters can register to vote through the system (e.g. request receive an absentee ballot), register for a digital voter ID, cast a digital ballot, scan a token, review their own voting status, and view the electronic ballot that they previously cast. In some embodiments, the voters 303 can view the electronic ballots they previously cast by using the token associated with their ballots by accessing their ballot in voter-ballot database 154 through block chain access layer 101 and user interface 131. In some embodiments, the voters 303 can also use the user interface to track the progress of physical ballots as it traverses the mail system both from the election office and its return to the election office.

In some embodiments, participants 302 can also be election registrars 304. In some embodiments, election registrars 304 can register their election on the block chain and define the election, including what date and time, what positions are open, who is running for those elections, and what ballot measures are on the ballot. Election registrars 304 can also create a template ballot for the election and view the voter status for each voter (e.g. who has voted or what they have voted on). In some embodiments, the registrars can access a list of which voters voted via the block chain without accessing the actual votes the voters cast.

In some embodiments, participants 302 can also include notaries 305. Notaries 305 can certify that the results of an election once all of the ballots have been cast. In some embodiments, the notaries 305 can certify the results of individual ballots through the use the of electronic Postmark® system 132. Once all of the ballots have been certified, Notaries 305 can then certify the results of the entire election.

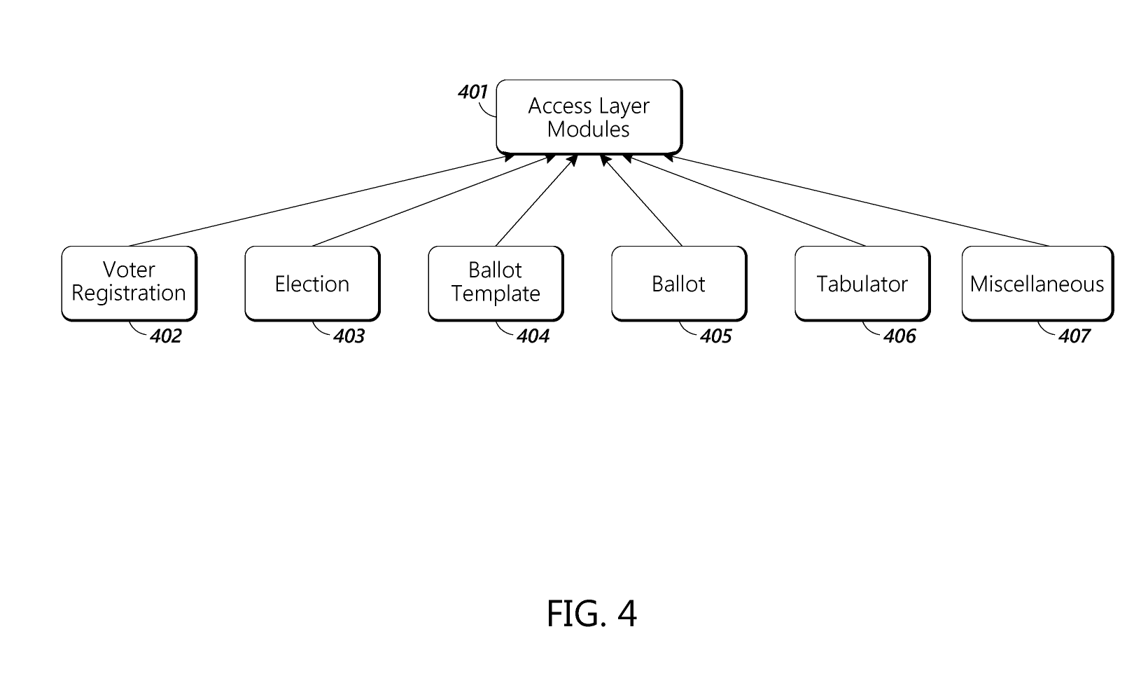

FIG. 4 is a software hierarchy diagram of the various software modules that can be used by the block chain access layer 101. Access layer modules 401 comprises numerous software modules that are used by block chain access layer 101 to perform various functions, as described below. In some embodiments, all the software modules take the form of Ethereum contracts in an Ethereum network. In some embodiments, one of the access layer modules 401 is a voter registration software module 402. Voter registration software module 402 can perform various functions such as registering a voter 303 to vote in the system (e.g. registering a voter as receiving an absentee ballot) and verifying a voter's identity. In some embodiments, the voter registration software module 402 can use identity services 130 and the identity management services database 151 in databases 150. In some embodiments, voter registration software module 402 can also query for the voter's address and query for the voter's ballot.

In some embodiments, access layer modules 401 can also comprise an election software module 403. Election software module 403 can be used to register an election with the system. In some embodiments, for example, election software module 403 can register elections that are happening in the state/county. In some embodiments, this includes what positions are up for election and who the candidates are for each position. In some embodiments, election software module 403 can also be used to query for previously registered elections.

In some embodiments, one of the access layer modules 401 is a ballot template software module 404. In some embodiments, ballot template software module 304 can be used to create ballot templates 203. In some embodiments, the created ballot templates 203 can be stored in the state/county election database 144 or in the ballot database 152. Ballot templates 203 are generic ballots that elaborate the details of an election. The ballot template can be a state/county specific template showing the various categories and sub-categories of the open positions and the candidates (including their affiliation) who are running for those positions, and any “ballot measures” seeking citizen referendum. In some embodiments, ballot template software module 404 can also query for and get a ballot template 203 from either ballot 152 or state/county election database 144, record the address for all of the candidates on the ballot, and then query for and get the various candidate addresses from state/county election database 144.

In some embodiments, another of the access layer modules 401 can be a ballot software module 405. Ballot software module 405 can be used to receive the ballots that are completed by voters. The ballot software module 405 can then be used to process the votes on the ballot.

In some embodiments, one of the access layer modules 401 can be a tabulator software module 406. In some embodiments, tabulator software module 406 appropriately buckets each vote received to the receiving candidate. The tabulator software module 406 ensures each vote that is recorded is counted properly and can summarize the votes received by various categories. In some embodiments, tabulator software module 406 can be used to record all of the votes from all of the received ballots and the get a total count of the vote for each candidate.

In some embodiments, another of access layer modules 401 can be a miscellaneous software module 407. In some embodiments, miscellaneous software module 407 can be used to perform functions to verify the block chain. For example, miscellaneous software module 407 can be used to verify the hash of the various blocks on the block chain and verify the signatures on the transactions of the block chain ledger.

As described above, the numerous software operations performed by the block chain powered vote by mail software rely on numerous types of data to be stored in the system. As explained above, in some embodiments, this data is stored in the various databases 150. In some embodiments, a portion of this data is stored directly on the block chain itself. In some embodiments, it is advantageous to store limited information on the block chain so that the block chain can be used to confirm the validity of the election, while preventing others from determining exactly who voted for who in the election. Table 1 show one example of what can be stored on and off the block chain for the various software modules and objects discussed above. In some embodiments, off block chain access is stored either in databases 150 or voter registry database 142, received ballots database 143, or state/county election database 144.

TABLE 1

| Software Object | | |
|---|---|---|
| Or Module | Off Chain | On Chain |
| Ballot Template 404 | Ballot ID | Ballot Template ID |
| | Election ID | ElectionID |
| | State | State |
| | County | County |
| | Details of Candidates, | Hash Of Off Chain |
| | Open Positions, and | Ballot Template |
| | Ballot Initiatives | Registrar |
| | Date Issued | Time Stamp |
| | Registrar ID | Validity From-To |
| | | Candidate Name |
| | | Candidate Address |
| Ballot 405 | Voter Tokenized ID | Hash(VoterID) |
| | ElectionID | ElectionID |
| | State | Token |
| | County | Status = 1 |
| | Votes | Hash Of Submitted |
| | Submission Time | Ballot |
| | Signature | Signature |
| Accumulator 209 | N/A | Election |
| | | Position |
| | | Candidate |
| | | Count |
| VSO 201 | Unique User | Unique User |
| | Identifier | Identifier |
| | Absentee Request | Status (Ballot |
| | Name | Request Or Voted) |
| | Address (Permanent) | Reference to Off |
| | Address (Current) | Chain Record |
| | Voting Jurisdiction | Hash of Absentee |
| | Requested | Request Application |
| | (State/County) | |
| | Contact Information | |
| | Telephone | |
| | Email | |
| | Absentee Voting | |
| | Request Date | |
| Vault 153 | Hash(VoterID) | N/A |
| | Token(encrypted) | |
| | Election (Token | |
| | Valid For) | |
| | Token-Expiry | |
| Tabulator 406 | N/A | AddressFrom |
| | | (Voter Address) |
| | | AddressTo |
| | | (Candidate Address) |
| | | Value = 1 |

As described elsewhere, in some embodiments, voters 303, election registrar 304, and notary 305 can interact with block chain access layer 101 through the use of user interface 131. In some embodiments, this user interface takes the form of a mobile app for use with a mobile phone, tablet, or similar device. In some embodiments, the user interface can also take the form of a website or other similar service accessed from a personal computer. In some embodiments, the app or website can take multiple forms based upon who is using the app. In some embodiments, the app or website can allow a voter to register for elections, query what elections the voter signed up for, scan the ballot, submit the ballot, query submitted the submitted ballot, and query and compare the submitted ballot with the ballot that was received by mail. In some embodiments, the app or website can allow an election registrar to create an election, create a ballot and view election results. In some embodiments, there is a login screen that is the same for both election registrars and voters.

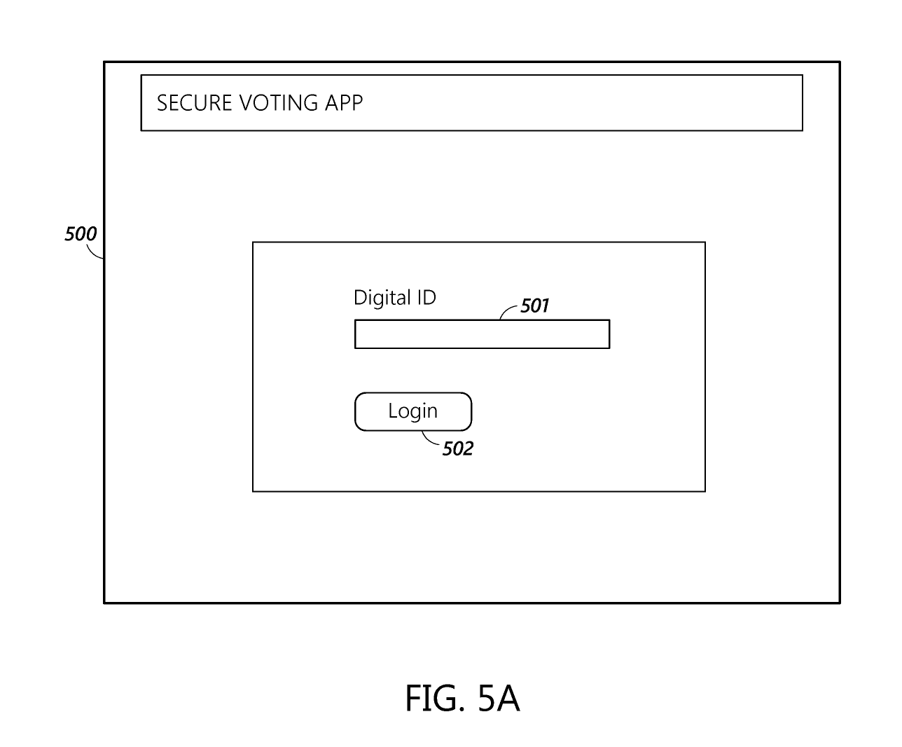

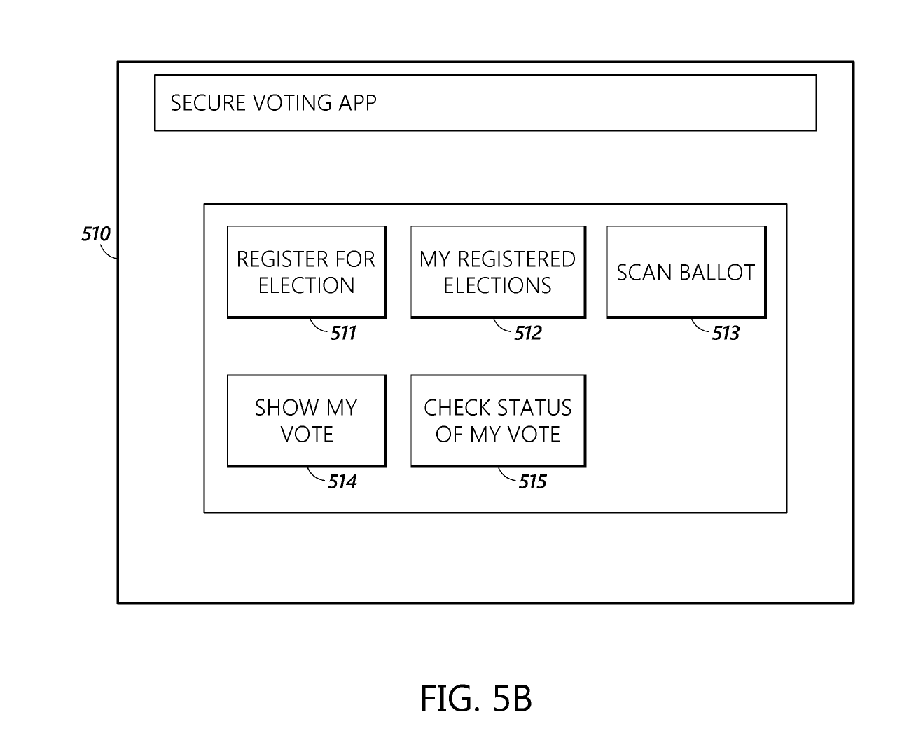

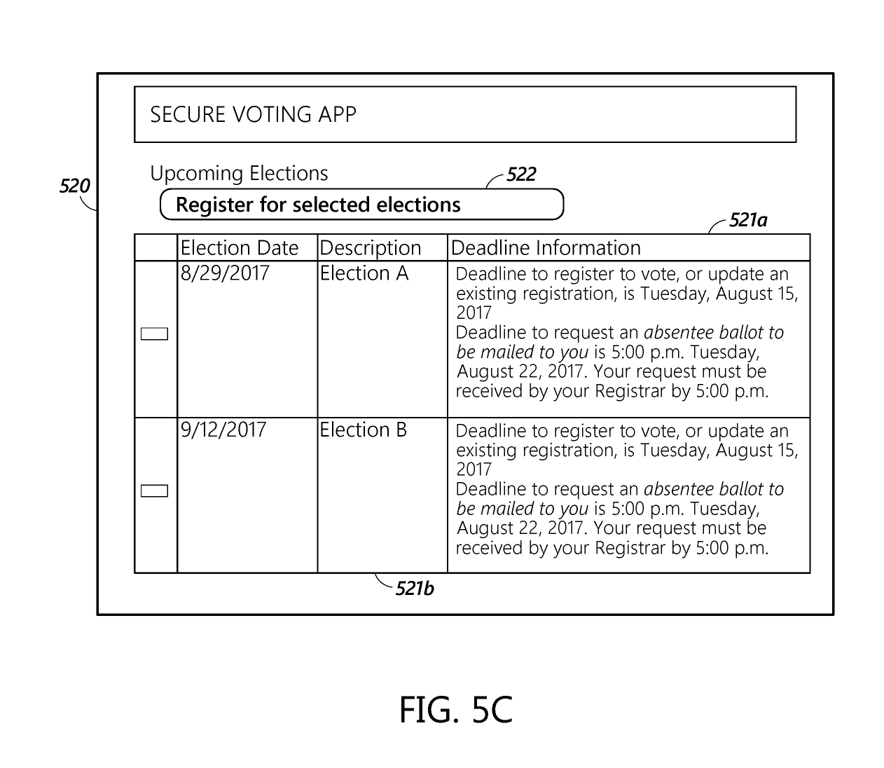

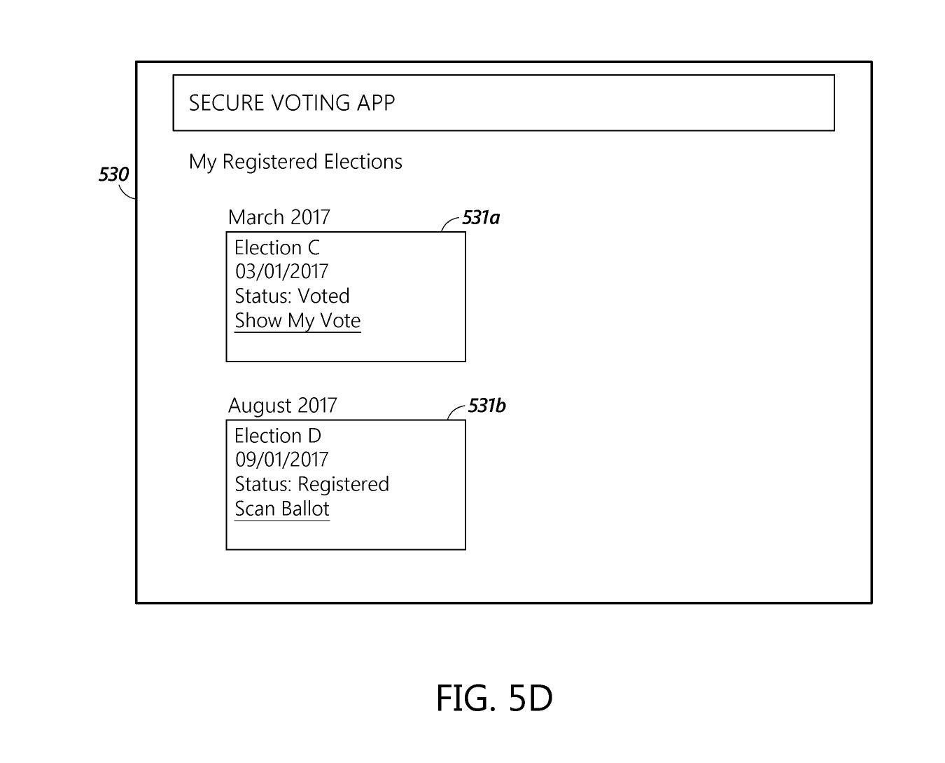

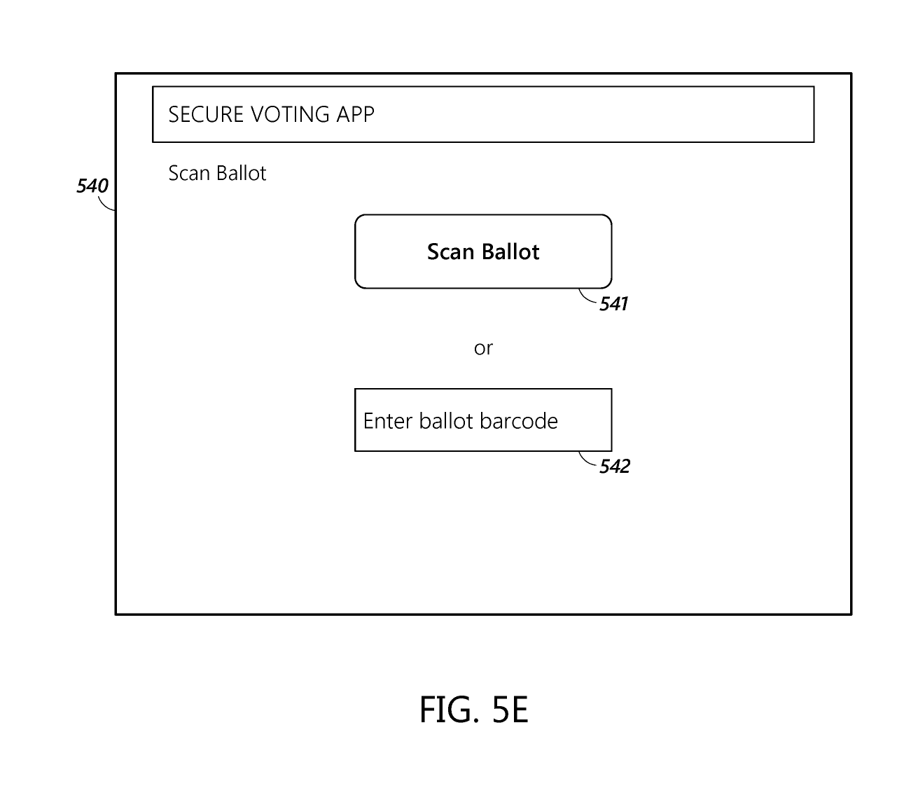

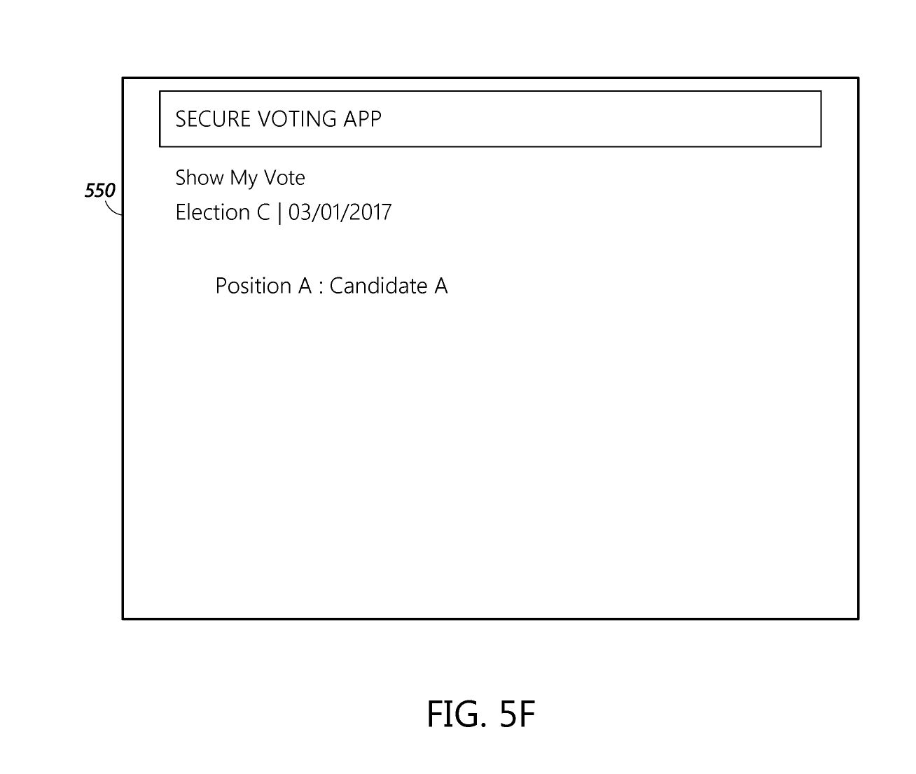

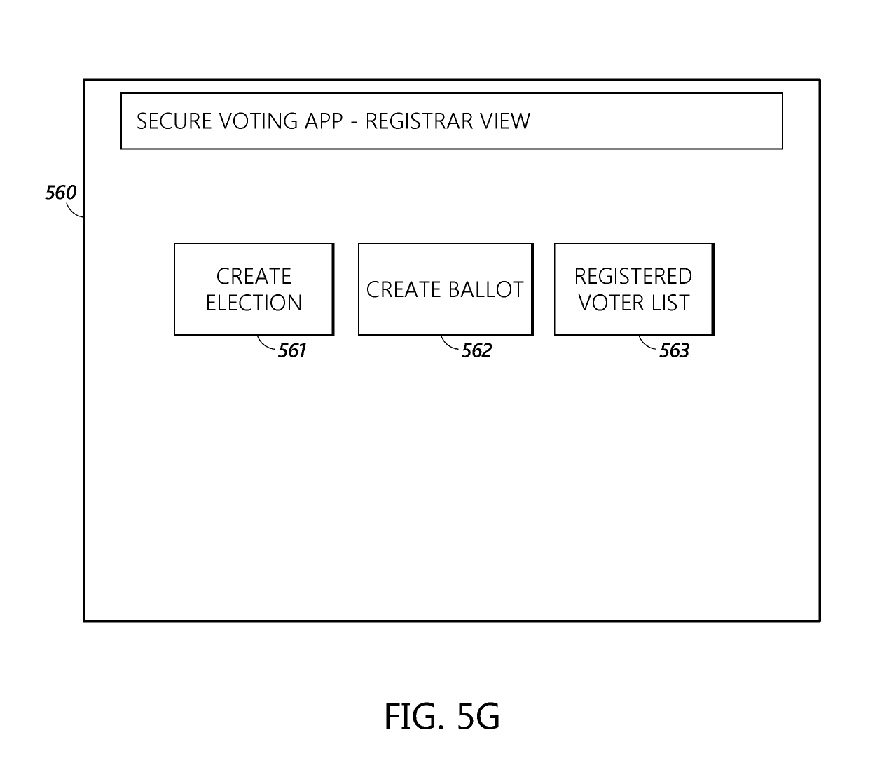

FIG. 5a displays one embodiment of a log in screen for this mobile app or website. FIG. 5 displays log in screen 500, which contains a field 501 for entering a digital ID and a virtual button 502 for logging into the system. In some embodiments, the digital ID is generated by the block chain powered vote by mail system 100 as described further below. To log in to the system the user can input their digital ID and then click or tap on virtual button 502. In some embodiments, once the digital ID has been submitted, the app or website then requests a password from the user. The password can be hashed and then sent, along with the digital ID, to identity management services database 151 to validate the credentials. In some embodiments, the app or website may also use two factor authentication by sending a code to an email address or phone number associated with the digital ID. The voter then keys the received code into the app or website.

FIG. 5b displays an embodiment of the main screen of the voting app as would be seen by a voter logging into the mobile app or website. As shown in FIG. 5b, the main screen can contain a variety of virtual functions that can be used to access various parts of user interface 131. For example, the user can register for elections with virtual button 511, display the elections the voters is registered for with virtual button 512, scan a ballot that has been cast with virtual button 513, show the votes that have been cast with virtual button 514, and check the status of a voters votes with virtual button 515. In some embodiments, the scanning function can use a camera in a mobile computing device

FIG. 5c displays an embodiment of a screen that can be used to register for various elections. As seen in FIG. 5c, screen 520 displays various elections (521a and 521b) that the voter can register for. In some embodiments, the voter can register for an election by checking the check marks in the displayed elections 521a and 521b and then click or tap virtual button 522 to register for the elections that are selected with the check marks. In some embodiments, the elections that the voter selects are recorded on the block chain along with the voter ID. In some embodiments, the elections that are displayed are retrieved by the website or app using oracles 141 form the appropriate election database 144. Further, when the voter registers for an election, an event is sent back to the county database that provided the oracle election info and then the database can update itself.

FIG. 5d shows another screen of an embodiment of the voting app or website. Screen 530 can display the elections (531a and 531b) that a user is already registered for.

FIG. 5e shows another screen of an embodiment of the voting app or website. FIG. 5e displays screen 540, which allows voters to scan ballots or otherwise enter ballots. In some embodiments, as discussed further below, voters can entered their completed ballots into the system by scanning their ballot. In some embodiments, the ballots can be scanned using the camera of a mobile computing device or by a scanner attached to a personal computer. The system can then identify what ballot is being submitted by looking at the scanned ballot barcode or other computer or machine readable identifier, as discussed further below. In some embodiments, users begin the scanning process by clicking or tapping on virtual button 541. In other embodiments, users enter their votes into the system by submitting a ballot barcode or other computer or machine readable identifier to the system through the use of the numeric code associated with the barcode or other computer or machine readable identifier. The users can enter this code into field 542 and then manually enter their votes into the system using a separate screen (not shown).

FIG. 5f shows another screen of an embodiment of the voting app or website. In screen 550, the voting app or website displays the various votes entered into the system by the voter though scanning their ballot.

FIG. 5g displays another screen of an embodiment of the voting app or website. Screen 560 displays a view of the main screen of the voting app or website as seen by the county registrar or other election management authority that creates and manages elections. In some embodiments, screen 560 has a virtual button 561 that allows the county registrar or other election management authority to enter another screen (not shown) to create an election. In some embodiments, screen 560 has a virtual button 562 that allows the county registrar or other election management authority to enter another screen (not shown) to create ballot for an election. In some embodiments, screen 560 has a virtual button 563 that allows the county registrar or other election management authority to enter another screen (not shown) that displays a list of registered voters.

In some embodiments, the various software modules and objects discussed above can be used to manage numerous functions of the block chain powered vote by mail system. In some embodiments, the system operates in the following manner. An election official creates a template ballot. A voter applies to vote absentee, and his or her identity is verified and approved by the system. Then, a ballot is generated for the voter with an attached identifier like a QR code, barcode, or other computer or machine readable identifier that obscures the identification information of the voter. In some embodiments, the identifier can be an electronic postmark. In some cases, this is done by hashing the voter information. The ballot is then mailed to the voter, who casts his or her votes, records the votes onto the block chain via the app or website and optionally mails the ballot back. The election officials can tally the vote using the electronic or paper ballot received from the voter.

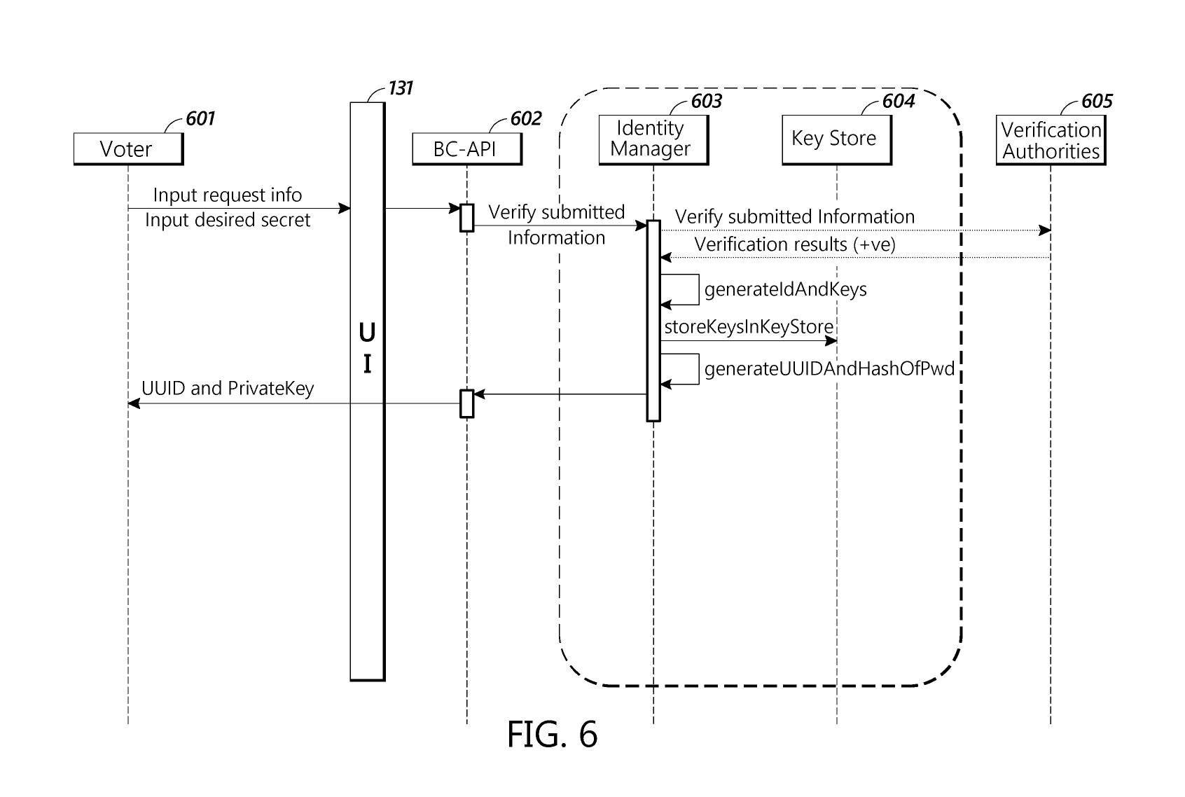

FIGS. 6-13 depict various data flow diagrams of some exemplary operations in various embodiments of the vote by mail system.

FIG. 6 displays a message flow diagram demonstrating an embodiment of how a voter could register with the block chain powered vote by mail system 100. Voter 601 inputs a desired user name, password, and other information into user interface 131. Voter 601 can also include a “secret,” for example the answer to a security question, such as the name of first pet that can also be used to identify the voter. In some embodiments, voter 601 can also input information necessary to verify the identity of the voter, such as a driver's license number, social security number or address.

User interface 131 sends that information to the block chain API 602, which then forwards the information on to identity manager 603. Identity manager 603 can then request that verification authorities 605 verify the identity of voter 601. In some embodiments, verification authorities 605 are government entities such as the Social Security Administration, state motor vehicle departments, the Federal Bureau of Investigation, and the United States Postal Service that can use the submitted information to verify the identity of voter 601.

Once verification authorities 605 have verified the identity of voter 601, the verification authorities send the results to identity manger 603. If verification authorities 605 confirm that the voter 601 is who he or she says he or she is, identity manager 603 will generate a unique user identifier (UUID) for the voter 601 and create a public/private key pair for the voter 601. The public/private key pair will later be used to sign transactions on the block chain. Once the keys have been generated, identity manger 603 sends the keys for storage into key store 604. In some embodiments, key store 604 can also store the user IDs and secrets of voters, as well as digital tokens that can be used to identify voters instead of user names and secrets. Finally, identity manager 603 generates a UUID and a hash of the user's password and sends the information on to the block chain API 602. Block chain API 602 then sends the unique user identifier and private key back to the voter.

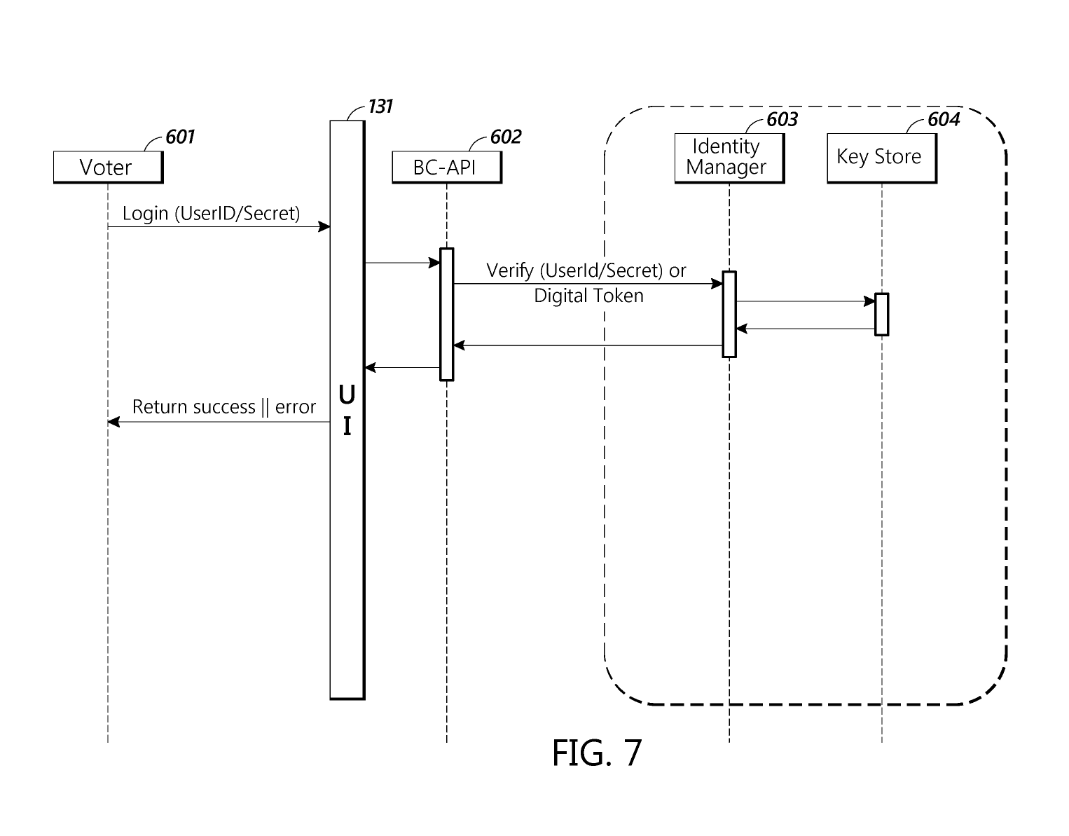

FIG. 7 depicts a message flow diagram demonstrating an embodiment of how a voter could log on to the block chain powered vote by mail system. In some embodiments, voter 601 will log in to the system by submitting his or her UUID, password, and secret to the user interface 131, which will then forward it on to block chain API 602. In some embodiments, block chain API 602 then requests that identity manager 603 verifies the user ID and secret. In some embodiments, the identity manager 603 then verifies the user ID secret or token with key store 604, which then responds back with the results to identity manger 603, which then forwards the results to block chain API 602. Block chain API 602 then returns a success or error message back the voter 601.

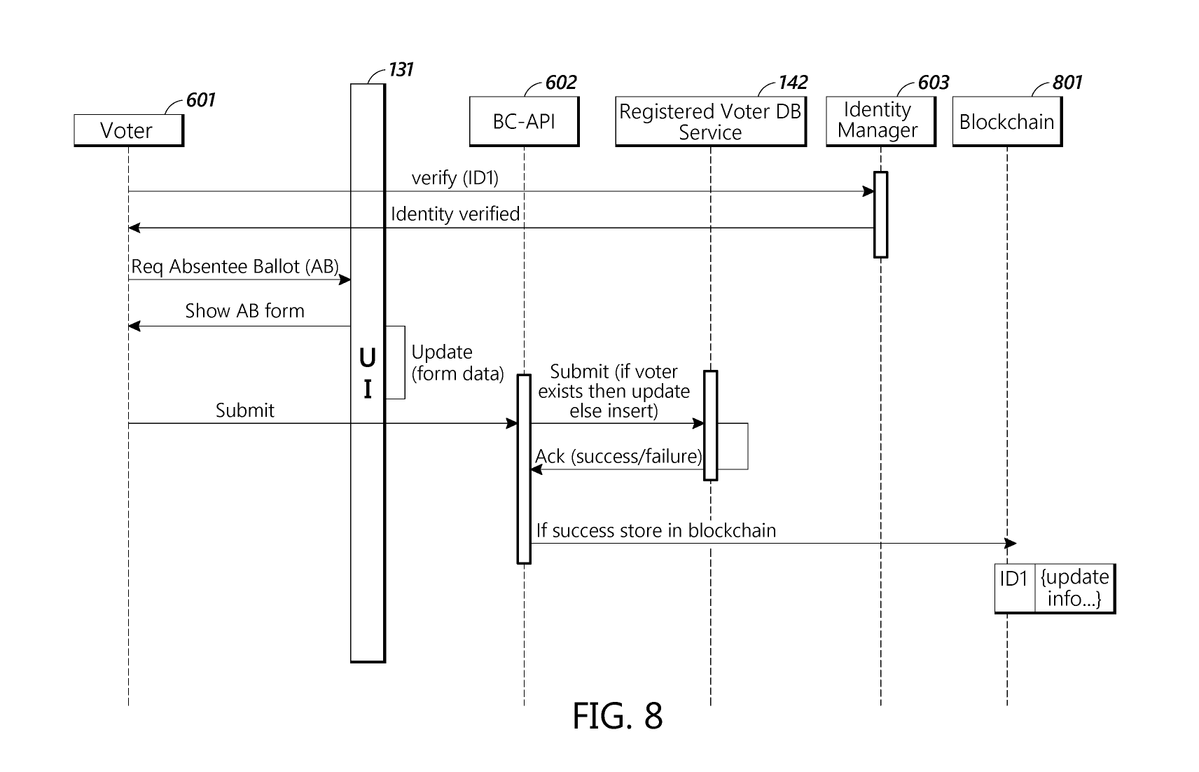

FIG. 8 depicts a message flow diagram demonstrating an embodiment of how a voter can request and fill out an absentee ballot with the system. First the voter 601 submits its specific identification number, e.g. ID1, to the identity manager 603 and has its identity verified by identity manager 603 in the manner previously described. The voter 601 then requests an absentee ballot from user interface 131, which then returns the absentee ballot. The voter then fills out/updates the absentee ballot using user interface 131 before submitting the ballot to block chain API 602. Block chain API 602 then confirms that the voter exists within the registered voter database service 142 and receives a success or failure message back. If the attempt at confirmation is successful, the block chain API then stores the submitted ballot onto the block chain. In some embodiments, the block chain API stores the submitted ballot on to the block chain by updating the information associated with the specific voter ID, e.g. ID1. In some embodiments, the voter-ballot database 154 can also determine if multiple votes were received from a particular voter and note this on the block chain as well. The voter-ballot database 154 can then determine whether actions should be taken to deal with the multiple votes, such as marking the voter for a fraud review or determining which of the votes to count.

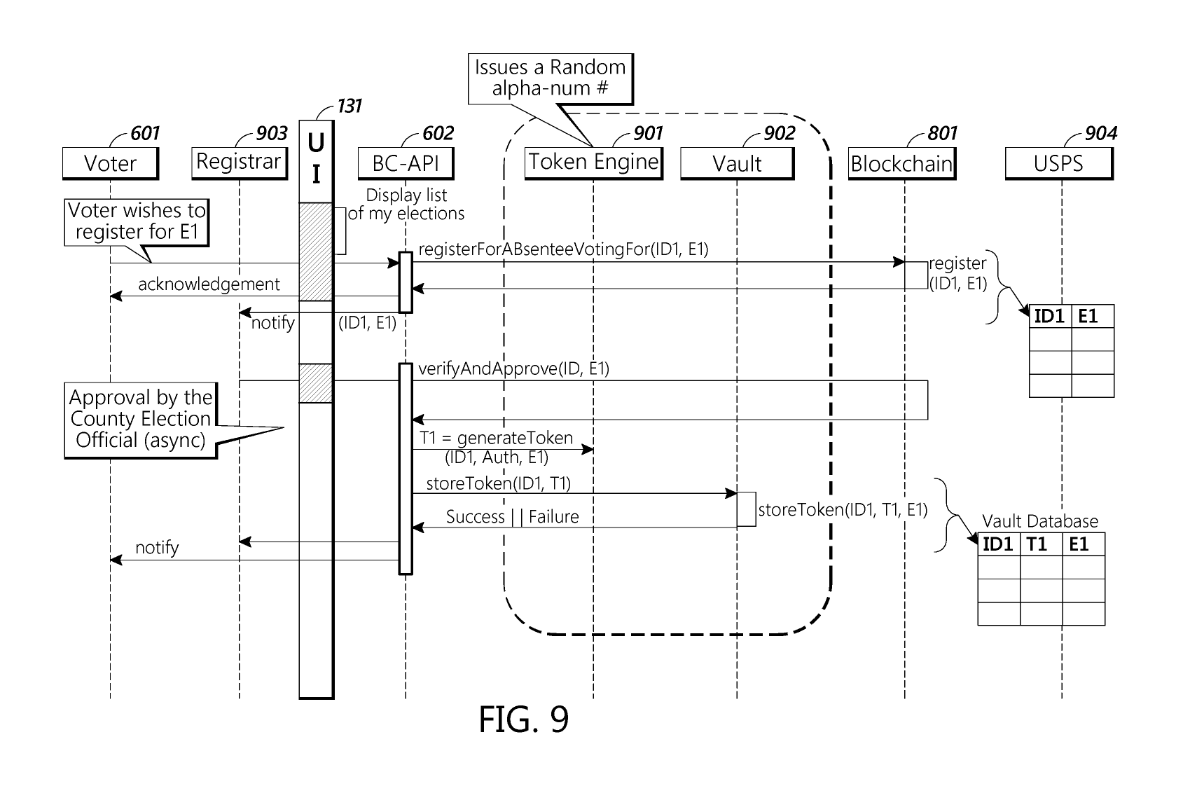

FIG. 9 depicts a message flow diagram demonstrating how a voter can request to register for an election. First, user interface 131 displays a list of elections for voter 601. Voter 601 then submits a request to register for an absentee ballot to block chain API 602 through user interface 131. In some embodiments, this request contains a specific user ID (ID1) and a unique alphanumeric election ID (E1). The block chain API 602 then registers the voter's request to block chain 801. In some embodiments, the block chain API 602 registers the user ID and election ID to the block chain 801. In some embodiments, block chain API 602 also transmits the user ID and election ID to the United States Postal Service 904 or other entity that will eventually be responsible for mailing the physical ballot. Next, block chain 801 sends acknowledgement back to block chain API 602 which forwards it on to voter 601 through user interface 131. Block chain API 602 then notifies registrar 903 that the voter 601 has registered for an election. In some embodiments, this notification contains the user ID and election ID. Next, registrar 903 then informs the block chain API 602 that the user is verified and approved for the election through user interface 131. In some embodiments, this message includes the relevant user ID and election ID. The block chain API 602 then stores this approval onto block chain API 602. Block chain API 602 then generates a token for the voter 601. In some embodiments, the token is generated by the user ID, authorization, and election ID. In some embodiments, the block chain API 602 generates the token in conjunction with a random alphanumeric sequence issued by token engine 901. The block chain API 602 stores the association between the token (T1), the user id (ID 1), and the election id (E1) in vault 902. In some embodiments, the block chain API 602 sends the information to the United States Postal Service 904 or other entity that will eventually be responsible for mailing the physical ballot. In some embodiments, the United States Postal Service 904 or other entity can use this information to generate a barcode, EPM®, or other computer or machine readable identifier that will be printed on the paper ballot that will allow the user to later scan the ballot. In some embodiments, the barcode or other computer or machine readable identifier is based on a hash of the election ID and user ID. Vault 902 returns a success/failure message to user block chain API 602. Finally, block chain API 602 notifies voter 601 and registrar 903 that the registration has occurred.

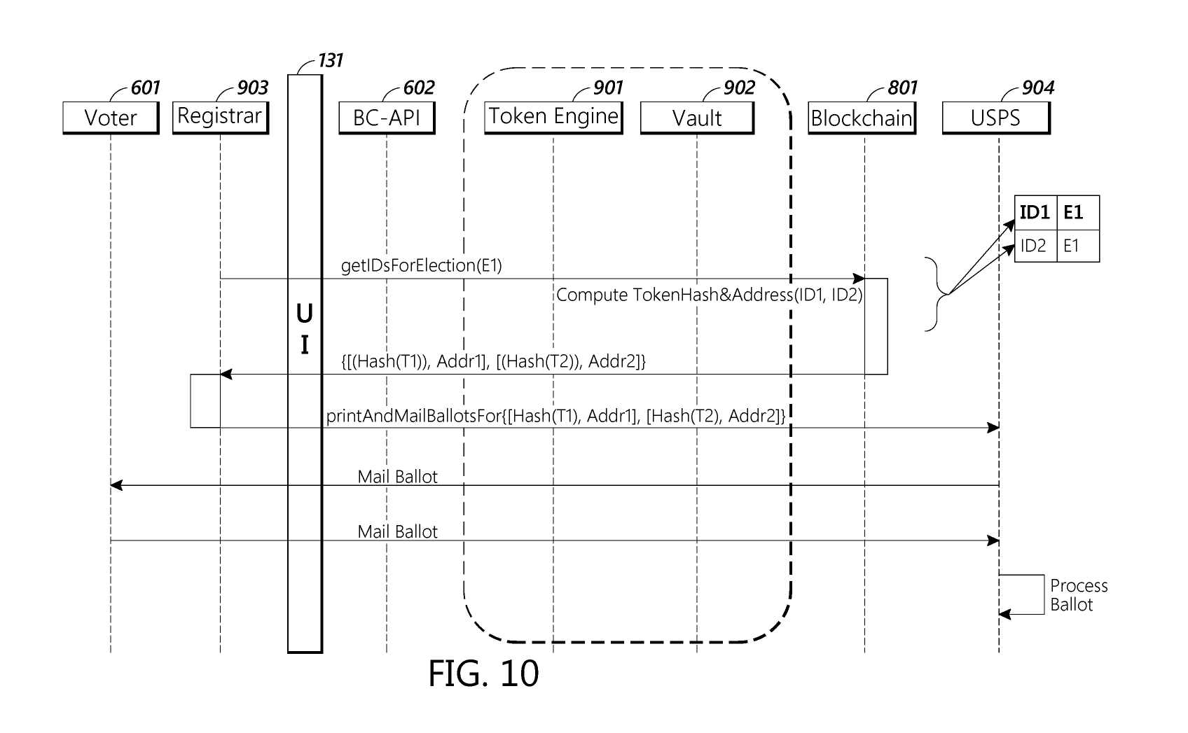

FIG. 10 is a message flow diagram demonstrating how the United States Postal Service or other mailing entity can mail ballots. In some embodiments, the registrar 903 requests the all of the user IDs registered for a particular an election ID from block chain 801. The block chain 801 responds with a hash of each token associated with the user and the address of the user. Registrar 903 then requests that the United States Postal Service 904 or other entity print the ballots based on the hashed tokens and addresses. In some embodiments, United States Postal Service 904 or other entity can then mail the ballots to the voter 601. In some embodiments, the United States Postal Service 904 or other entity can notify the voter 601 when the ballot is placed in the mail and where the ballot is in the mail system as the ballot is mailed.

In some embodiments, the voter 601 can then receive the ballot from the postal service, fill out the ballot, and mail it back through USPS 904. In some embodiments, USPS 904 can then use mail ballot processor 134 to read the barcodes or other computer or machine readable identifier attached to the physical ballots and determine if the mailed ballot was received in time for the votes to count in the election based on the time that the machine readable identifier was scanned by a mail processing system. In some embodiments, the mail ballot processor 134 can also be used to determine which entity should count a particular received ballot based on the machine readable identifier. For example, the mail ballot processor could determine that a particular county or state counting office was responsible for counting the ballot. The ballot can then be mailed on to the appropriate entity for counting.

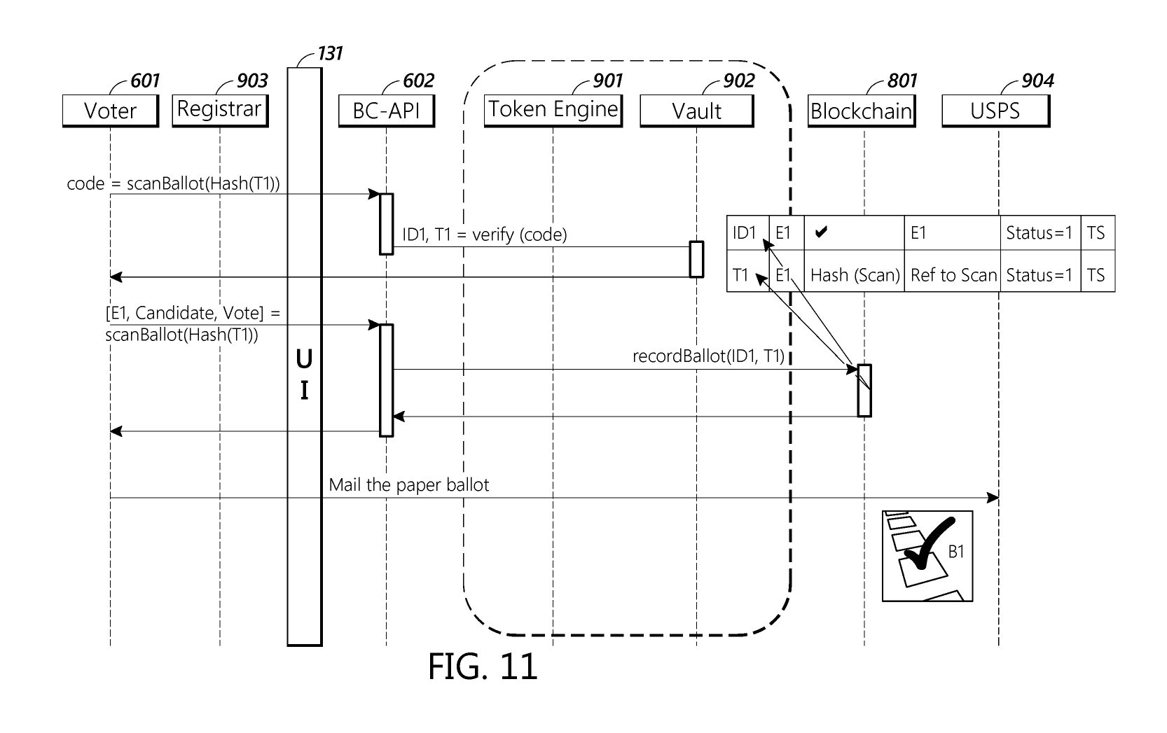

FIG. 11 shows a message flow diagram for how a voter can receive a mailed ballot and then submits and mails the ballot. First, the voter 601 scans the barcode or other computer or machine readable identifier on the mailed ballot. In some embodiments, the barcode or other computer or machine readable identifier is formed based on a previously generated hash of the token (T1) and user ID (ID1). In some embodiments, the scan is sent to block chain API 602 which verifies this scanned barcode or other computer or machine readable identifier with vault 902. In some embodiments, these steps are accomplished by having voter 601 manually complete the paper ballot. Then voter 601 logs on to user interface 131 using user ID as previously discussed and chooses a “Scan Code” option on the user interface 131 to scan the barcode or other computer or machine readable identifier on the mailed ballot. The barcode or other computer or machine readable identifier is passed to the vault 902 which can compare it to hashes of previously stored tokens.

The voter 601 can then scan the individual votes on the ballot and submit them to block chain API 602. Block chain API 602 can record the ballot on block chain 801. In some embodiments, voter 601 performs the scan through user interface 131. User interface 131 can use a process choices feature to accumulate the scanned choices and, in some embodiments, confirm their accuracy by checking with ballot database 152. The choices can be stored in a “voter ballot” internal database in user interface 131 until they are ready to be submitted. Once the voter 601 wants to submit the ballot, the user interface will use the “Submit Ballot” feature to fetch the relationship between the voter ID and the token. The ballot choices are saved in the voter-ballot off-chain database 154 along with voter ID, ballot barcode or other computer or machine readable identifier, hash of the digitally stored ballot, and timestamp. Then the voter ID, token, ballot hash, reference to the ballot in the voter-ballot database 154 and time stamp are recorded on the block chain 801. Finally, block chain 801 can send a success message back to voter 601 through block chain API 601 and the voter can mail the paper ballot to the United States Postal Service 904 or other entity.

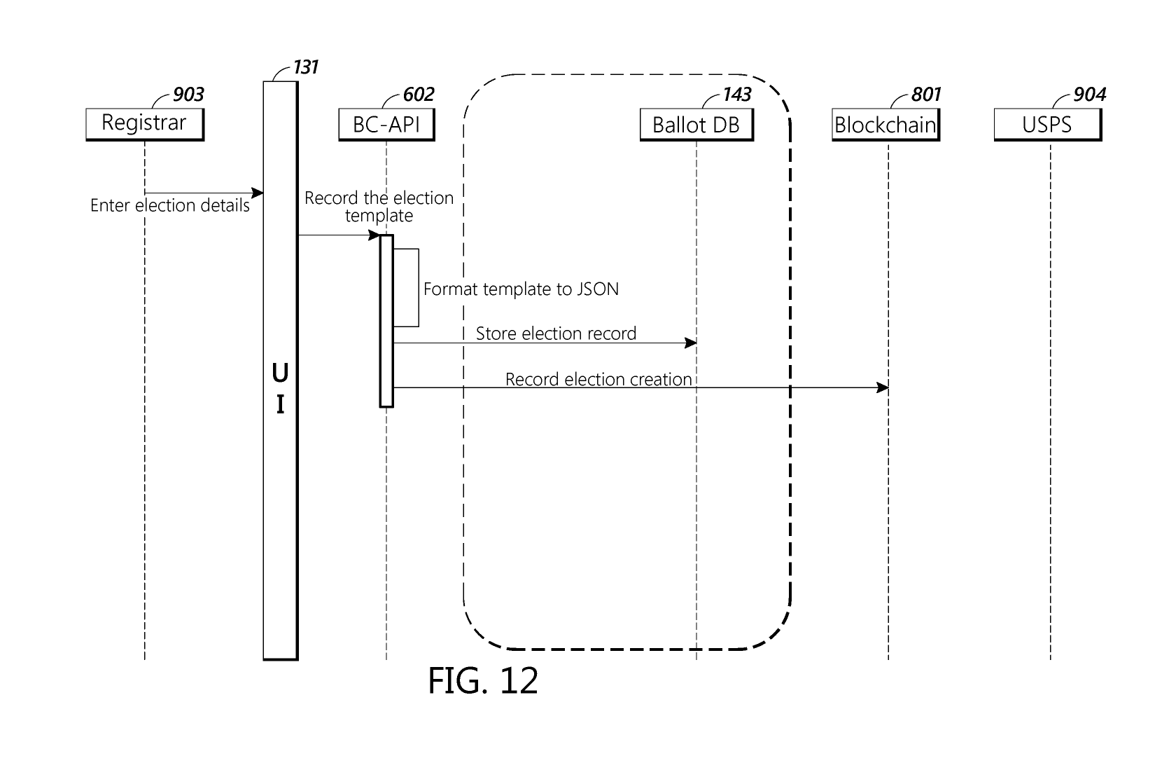

FIG. 12 depicts a message flow diagram showing how a registrar can create an election template. First Registrar 603 enters the election details into user interface 131. User interface 131 then records the election template block chain API 602. In some embodiments, the block chain API 602 can reformat the election template into the JSON format. The block chain API then stores the election record into ballot database 142 and records the election creation on block chain 801.

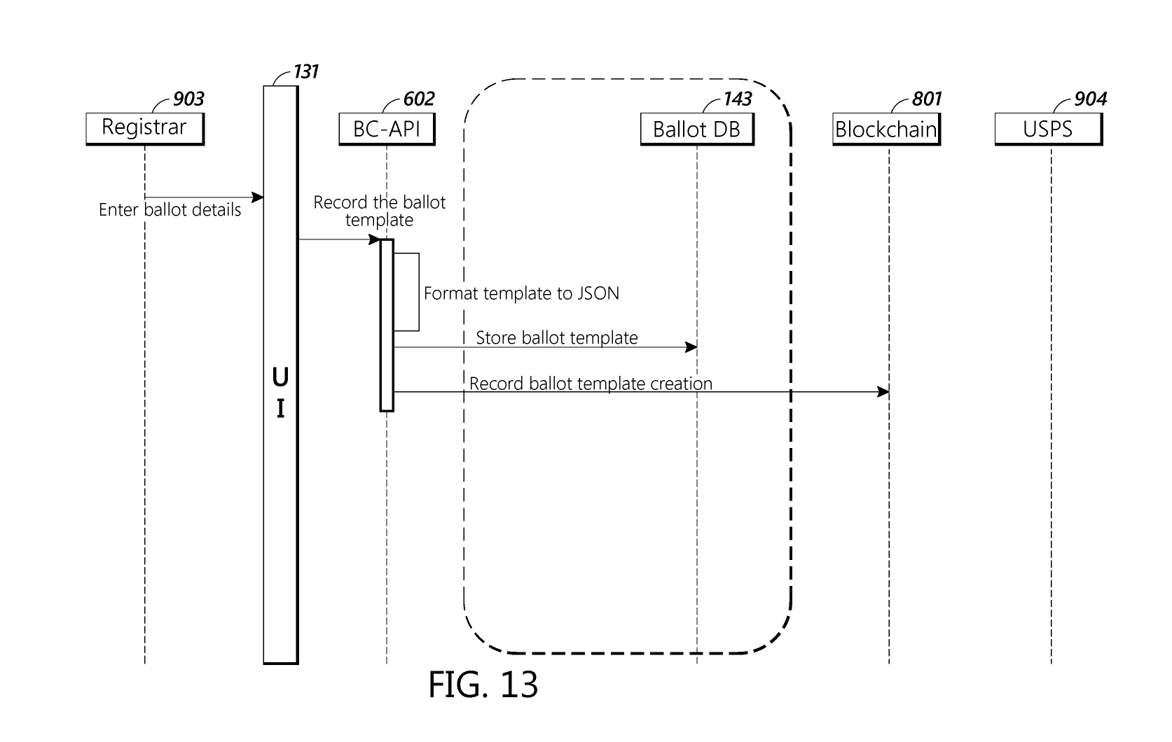

FIG. 13 depicts a message flow diagram showing an embodiment of how a registrar can create a ballot template. First Registrar 603 enters the ballot details into user interface 131. User interface 131 then records the ballot template block chain API 602. In some embodiments, the block chain API 602 can reformat the ballot template into the JSON format. The block chain API then stores the ballot template into ballot database 142 and records the ballot template creation on block chain 801.

In some embodiments, some parts of the system can also be used to create a secure voting procedure using secure electronic identity labels for in person voting. In some embodiments, potential voters can visit their state's official voting registration for voting; or call to request official documentation be mailed to the nearest state's USA Voter Registration center in the state that the voter currently resides in, or county's USA Embassy. The voters can then have their identity validated at the approved polling registration station for in-person validation and photo taken for submission prior to receiving special form. If the voter is not in the particular state the voter can call the state's USA Voter Registration Center in the state or country the voter is located in. In some embodiments, this process can be handle in whole or in part by identity services 130.

In some embodiments, as the voter's identity is being verified, the verification information can be transmitted through voter registry 142 to system 100. The EPM 132 can then generate a particular electronic barcode associated with that voter. In some embodiments, the EPM 132 can also generate special coding identifiers, such as bar codes, that represent identifying information about the voter, such as state, voter ID, issuer, voter residence, voter mailing address, age, sex, birth, education level, etc. In some embodiments, the special coding identifiers and electronic barcode are then printed on a special form used as part of the verification process. These forms can also be electronically signed and dated by the system and the state issuing the form.

Once the voter's identification has been verified, the voter can then go to the polls where, a polling worker can confirm the voter's identity. The poll worker can then issue a special electronic postmarked stamped voting card. The voting card can be taken to the polling machine, where it is inserted. The voting machine only allows people with a voting card to vote and will only allow a person with a particular electronic postmark to vote once. Once the vote has been cast, the voting machine can issue a receipt containing there voting information. The vote can then be stored on the block chain. In some embodiments, the vote can also be stored in a local server, main tallying server and an archive server. Further, the voting cards themselves are stored by the machine as a physical record of who voted.

Various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and steps described above. Whether such functionality is implemented in hardware or software depends upon the particular application and design constraints imposed on the overall system.

In one or more aspects, the functions described herein may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable storage medium. The steps of a method or algorithm disclosed herein may be implemented in a processor-executable software module which may reside on a computer-readable storage medium. Computer-readable storage media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above can also be included within the scope of computer-readable storage media. Additionally, the operations of a method or algorithm may reside as one or any combination or set of codes and instructions on a machine readable storage medium and computer-readable storage medium, which may be incorporated into a computer program product.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Instructions refer to computer-implemented steps for processing information in the system. Instructions can be implemented in software, firmware or hardware and include any type of programmed step undertaken by components of the system.

As can be appreciated by one of ordinary skill in the art, each of the modules of the invention may comprise various sub-routines, procedures, definitional statements, and macros. Each of the modules are typically separately compiled and linked into a single executable program. Therefore, the description of each of the modules is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware. A person of skill in the art will understand that the functions and operations of the electrical, electronic, and computer components described herein can be carried out automatically according to interactions between components without the need for user interaction.

The foregoing description details certain embodiments. It will be appreciated, however, that no matter how detailed the foregoing appears in text, the development may be practiced in many ways. It should be noted that the use of particular terminology when describing certain features or aspects of the development should not be taken to imply that the terminology is being re-defined herein to be restricted to including any specific characteristics of the features or aspects of the development with which that terminology is associated.

While the above detailed description has shown, described, and pointed out novel features of the development as applied to various embodiments, it will be understood that various omissions, substitutions, and changes in the form and details of the device or process illustrated may be made by those skilled in the technology without departing from the intent of the development. The scope of the development is indicated by the appended claims rather than by the foregoing description. All changes which come within the meaning and range of equivalency of the claims are to be embraced within their scope.

1. A system for secure voting, the system comprising:
a computer processor configured to:
process ballot creation information to create a ballot template;
process voter identification information to create at least one pseudo-anonymous voter ID; and
generate at least one ballot using the ballot template and pseudo-anonymous voter ID;
a communication device configured to provide the at least one ballot to a voter associated with pseudo-anonymous voter ID;
a secure database configured to:
receive ballot selections from the voter;
store the ballot selections in a manner associated with the at least one pseudo-anonymous voter ID.

2. The system of claim 1 wherein the computer processor is further configured to generate a token associated with a particular pseudo-anonymous voter ID that allows the voter associated with the particular pseudo-anonymous voter ID to vote in a particular election.

3. The system of claim 1 further comprising a printer configured to print a physical ballot based on the at least one ballot generated the computer processor.

4. The system of claim 1 wherein the secure database is further configured to retrieve the ballot selections when requested by the voter associated with the at least one pseudo-anonymous voter ID.

5. The system of claim 1 wherein the secure database is configured to store the ballot information on a block chain.

6. The system of claim 1 wherein the secure database is further configured to only store the ballot selections upon receiving a scan of a physical ballot containing an identifier associated with the particular pseudo-anonymous voter ID.

7. A method for secure voting, the method comprising:
processing ballot creation information to create a ballot template;
processing voter identification information to create at least one pseudo-anonymous voter ID;
generating at least one ballot using the ballot template and pseudo-anonymous voter ID;
providing the at least one ballot to a voter associated with pseudo-anonymous voter ID;
receiving ballot selections from the voter; and
storing the ballot selections in a manner associated with the at least one pseudo-anonymous voter ID.

8. The method of claim 7 further comprising generating a token associated with a particular pseudo-anonymous voter ID that allows the voter associated with the particular pseudo-anonymous voter ID to vote in a particular election.

9. The method of claim 7 further comprising printing a physical ballot based on the at least one ballot generated the computer processor.

10. The method of claim 7 further comprising retrieving the ballot selections when requested by the voter associated with the at least one pseudo-anonymous voter ID.

11. The method of claim 7 further comprising storing the ballot information on a block chain.

12. The method of claim 7 further comprising only storing the ballot selections upon receiving a scan of a physical ballot containing an identifier associated with the particular pseudo-anonymous voter ID.

13. A system for secure voting, the system comprising:
a computer processor configured to:
create a ballot template using ballot creation information;
create a pseudo-anonymous voter ID using voter identification information; and
generate at least one ballot using the election template and pseudo-anonymous voter ID;
a printer configured to print a physical ballot based on the generated at least one ballot, the ballot comprising a ballot identifier based on the pseudo-anonymous voter ID; and
a mail processing device configured to:
receive the physical ballot from a voter; and
associate the physical ballot with the voter based on the ballot identifier.

14. The system of claim 13, wherein the mail processing device is further configured to:
identify the address of the entity responsible for counting the votes on the physical ballot based on ballot identifier; and
direct the physical ballot on to the entity responsible for counting the votes on the physical ballot.

15. The system of claim 13, further comprising a secure database configured to:
receive ballot selections from the voter; and
determine if the secure database had previously received ballot selections from the same voter.

16. The system of claim 15 wherein the secure database is further configured to flag the voter for a fraud investigation if the secure database had previously received ballot selections from the same voter.

17. The system of claim 15 wherein the secure database is further configured to designate at least one of the ballot selections to not be counted in a final vote tally.

18. A method for secure voting, the method comprising:
creating a ballot template using ballot creation information;
creating a pseudo-anonymous voter ID using voter identification information; and
generating at least one ballot using the election template and pseudo-anonymous voter ID;
printing a physical ballot based on the generated at least one ballot, the ballot comprising a ballot identifier based on the pseudo-anonymous voter ID;
receiving the physical ballot from a voter; and
associating the physical ballot with the voter based on the ballot identifier.

19. The method of claim 18 further comprising:
identifying the address of the entity responsible for counting the votes on the physical ballot based on ballot identifier; and
directing the physical ballot on to the entity responsible for counting the votes on the physical ballot.

20. The method of claim 18, further comprising:
receiving ballot selections from the voter; and
determining if a secure database had previously received ballot selections from the same voter.

21. The method of claim 18 further comprising flagging the voter for a fraud investigation if the secure database had previously received ballot selections from the same voter.

22. The method of claim 18 further comprising designating at least one of the ballot selections to not be counted in a final vote tally.
